(19) United States
(12) Patent Application Publication
(10) Pub. No.: US 2025/0045569 A1
(43) Pub. Date: Feb. 6, 2025

(54) Methods and Apparatus For Recomputing Neural Networks

(71) Applicant: Expedera, Inc., Santa Clara, CA (US)

(72) Inventors: Ramteja Tadishetti, Sunnyvale, CA (US); Sharad Vasantrao Chole, San Jose, CA (US); Shang-Tse Chuang, Los Altos, CA (US); Siyad Chih-Hua Ma, Palo Alto, CA (US)

(21) Appl. No.: 18/768,801

(22) Filed: Jul. 10, 2024

Related U.S. Application Data
(60) Provisional application No. 63/530,903, filed on Aug. 4, 2023.

(51) Int. Cl. G06N 3/0464

(52) U.S. Cl. CPC G06N 3/0464

(57) ABSTRACT

Disclosed are systems and methods for processing a multilayer neural network incorporating skip connections while reducing the memory footprint and processing time of processing a neural network. The method comprises loading within a memory partition with a portion of an input tensor and a portion of layer weights associated with computing a portion of the one or more intermediate layer tensors associated with a first portion of the skip connection tensor. Next, a neural processing unit is used to recompute portions of the skip connection tensor using the portion of the input tensor and associated weights. Upon completion, the memory utilized for the recomputing is free for further computations.

### CROSS-REFERENCE TO RELATED APPLICATIONS

This application claims the benefit and priority of U.S. Provisional Application Ser. No. 63/530,903, filed on Aug. 4, 2023, entitled “Methods and Apparatus for Recomputing Neural Networks,” all of which are hereby incorporated by reference in its entirety, including all references and appendices cited therein, for all purposes.

### TECHNICAL FIELD

The present invention relates to the field of artificial neural network processing. In particular, but not by way of limitation, the present invention discloses methods, control systems, and operating techniques for executing artificial neural network processing operations.

### BACKGROUND

Computer system designers are endlessly attempting to design faster computer systems to solve computation problems quickly. Faster computer systems allow for extremely complex computational problems to be addressed, such as weather prediction, protein-folding, celestial mechanics, artificial intelligence, and complex three-dimensional video renderings. As the computers become ever faster, the computational models being simulated can be made ever more detailed, thus rendering ever more accurate computational results.

To design faster computer systems, computer scientists and engineers employ many different techniques. One of the simplest techniques is to increase the clock speed at which digital computer processor systems operate. However, it is becoming much more difficult to increase the clock speed due to the physics of current transistor materials. Processing ever wider data structures can also increase computer performance, but this technique only helps for certain types of computational tasks that can efficiently take advantage of wider data structures. Two of the current popular techniques for improving processing speeds is to use parallel processing techniques, such as implementing multiple computational cores within a computer processor or combining thousands of different computer systems on a network to cooperate on a single computational problem.

One of the computer science fields most in need of specialized processors to improve performance is the field of Artificial Intelligence (AI). Artificial Intelligence is increasingly being used for a wide variety of complex tasks such as image recognition, High-Performance Computing (HPC), scientific computing, machine learning, data mining, natural language recognition, self-driving vehicles, and many other problems. Artificial Intelligence applications tend to rely very heavily upon mathematical matrix calculations from the mathematical field of linear algebra. Specifically, mathematical matrix operations are generally needed to implement artificial neural networks (ANNs). Artificial neural networks learn from a set of training data and then retain that learning in the form of neural network weight matrix values. The neural network can then later apply that learning stored within the neural network weight matrix values to new input data in order to make logical inferences about that new input data.

Due to the very heavy usage of difficult mathematical matrix computations in artificial neural networks, artificial intelligence is a computationally intensive field of computer science that is desperately in need of computational optimizations. One of the most popular techniques to improve artificial intelligence application performance is to create specialized digital processing circuits for the performing mathematical matrix operations needed to implement a neural network. Specialized matrix processors take advantage of the parallelism inherent in mathematical matrix operations and thus efficiently execute the matrix calculations commonly used in artificial intelligence.

Artificial Intelligence processing systems perform vast amounts of linear algebra mathematical matrix calculations. The mathematical matrix calculations performed by artificial intelligence systems are often performed repeatedly with the same set of weight matrices but with different input data vectors. Similarly, a data vector may need to be processed through several neural network layers requiring many mathematical matrix calculations that generate many intermediate results before calculating a final output result.

All these complex matrix mathematical calculations required for neural network based artificial intelligence applications involve moving very large amounts of data from memory storage and then into and out of the specialized neural network digital processing circuits. In particular, neural network matrix processing operations require large weight matrices and large input data vectors to be loaded into matrix processing circuits for the matrix operations. The memory access operations for the large weight matrices needed for neural networks can consume a significant amount of power, consume significant amounts of memory bandwidth, and cause latency by processing elements waiting for data. Without careful coordination, all these memory access operations for the weight matrices can slow down the performance of the dedicated neural network processor. Therefore, it is desirable to develop new techniques for organizing and scheduling memory access operations used within neural network processing in a manner that optimizes the performance.

### SUMMARY

Methods and systems are provided for processing multilayer neural networks incorporating skip connections. The method and system directed to recomputing one or more skip connection tensors when used during later stage processing in the multilayer neural network. This method is used instead of storing and retrieving the skip connection tensor.

In one aspect of the disclosure relates to a method for recomputing a skip connection tensor within a multilayer neural network. In some implementations, the method involves loading within a memory partition with a portion of an input tensor. Additionally, a neural network layer weights are loaded. These weights relate with the portion of layer weights associated with computing a portion of the one or more intermediate layer tensors associated with the portion of the skip connection tensor. To describe this in another way, there can be several layers between the input tensor and the skip connection tensor. Because the network is not fully connected, the entire input layer does not have to be fully computed to perform computations for the subsequent layers. A slice from a portion of the input tensor to the skip connection tensor can be computed.

Next a neural processing unit (NPU) is used to recompute the skip connection tensor. The computation can include all or part of the skip connection tensor. Portions or segments of the skip connection tensor can be recomputed sequentially or in any order. The recomputing the portion of the skip connection tensor includes accessing from on or off the NPU chip the portion of layer weights associated layers that are used to from the multilayer neural network for generating a first portion of the skip connection tensor using the portion of the intermediate layer tensors associated with the first portion of the skip connection tensor; and

freeing the memory within the memory partition for the portion of the input tensor and the portion of layer weights associated with computing a portion of the all or part of the skip connection tensor within the on-chip memory partition.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1A illustrates a conceptual diagram of a single-layer artificial neural network.

FIG. 1B illustrates a conceptual diagram of a three-layer artificial neural network.

FIG. 1C illustrates the three-layer artificial neural network of FIG. 1B with more than one added data skip connection.

FIG. 1D illustrates a conceptual diagram of a two-layer artificial neural network that does not have dependencies between every input data vector value and every output data vector value.

FIG. 2A illustrates a graphical representation of the well-known U-NET convolution neural network used for image processing in biomedical applications.

FIG. 2B illustrates the well-known U-NET convolution neural network of FIG. 2A, wherein the data layers are labeled.

FIG. 3A illustrates a first half of a timing diagram of processing the U-NET convolution neural network of FIG. 2A by storing all of the skip connection tensor.

FIG. 3B illustrates a second half of a timing diagram of processing the U-NET convolution neural network of FIG. 2A by reading from memory the skip connection tensor.

FIG. 4A illustrates a U-NET convolution neural network of FIG. 2A, wherein a first skip connection tensor is discarded and recomputed for use in later layers.

FIG. 4B illustrates a U-NET convolution neural network of FIG. 4A, wherein a first skip connection tensor is discarded and recomputed for use in later layers and the data layers are labeled.

FIG. 5A illustrates a U-NET convolution neural network wherein a first and second skip connection tensor is discarded and the first and second skip connection tensor are recomputed for use in later layers and the data layers are labeled.

FIG. 5B illustrates a first-half timing diagram of processing the U-NET convolution neural network of FIG. 5A by storing and reading the skip connection tensor from memory.

FIG. 5C illustrates a second half of a timing diagram of processing the U-NET convolution neural network of FIG. 5A by reading from memory the skip connection tensor.

FIG. 6 illustrates a multilayer neural network embodiment in relation to memory partitions.

FIG. 7 is a flow chart for the method of recomputing a skip connection tensor.

FIG. 8 is a diagram of a multilayer neural network system.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required to practice the present invention. For example, although some of the example embodiments are disclosed with reference to the U-NET Convolutional Neural Network, the disclosed techniques may be used with any type of artificial neural network. Example embodiments may be combined, other embodiments may be utilized, or structural, logical, and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

### Overview

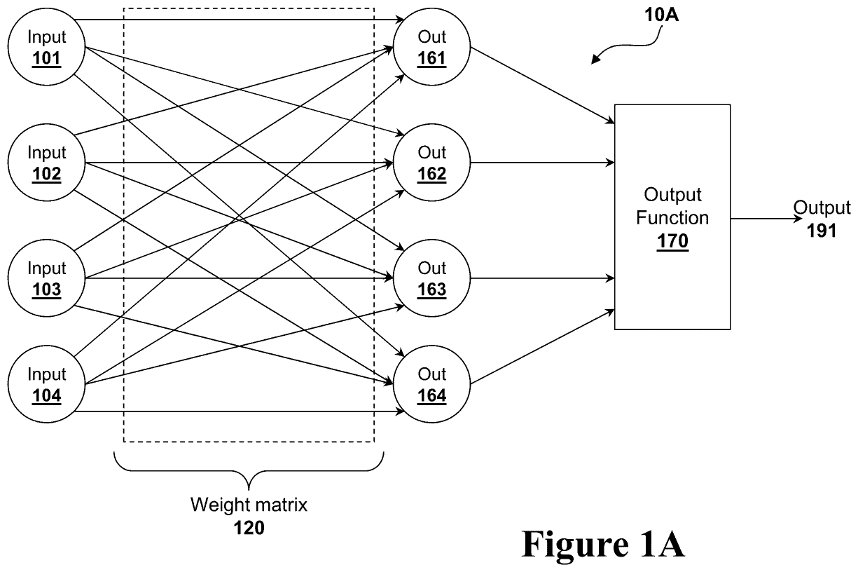

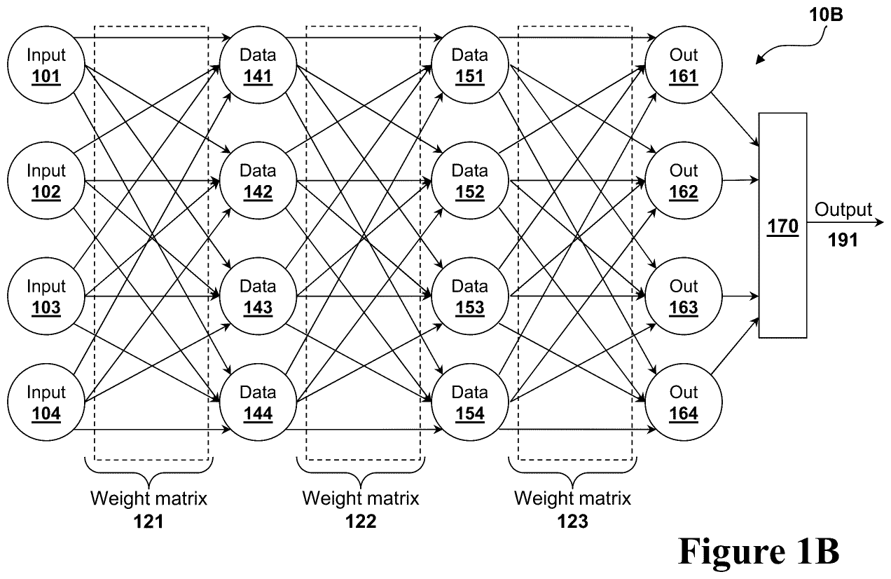

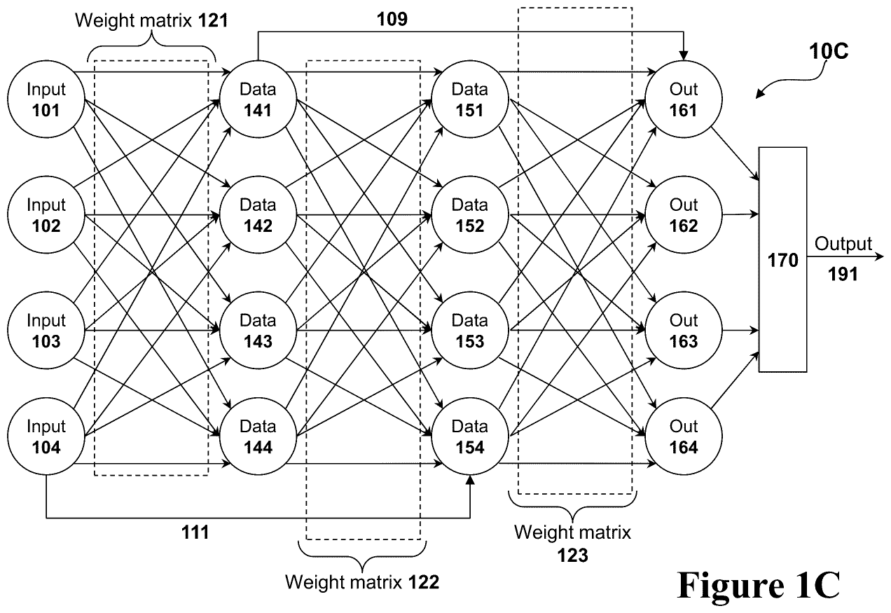

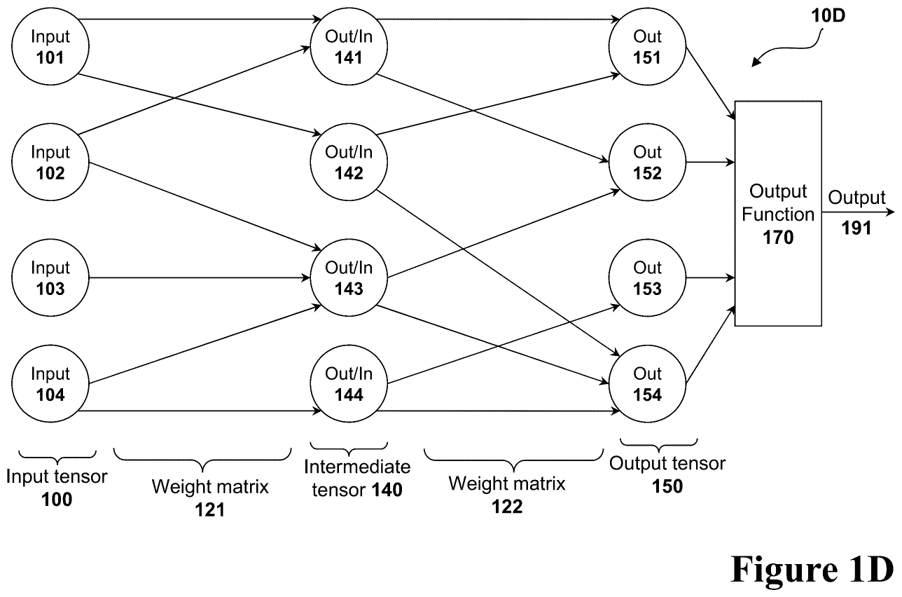

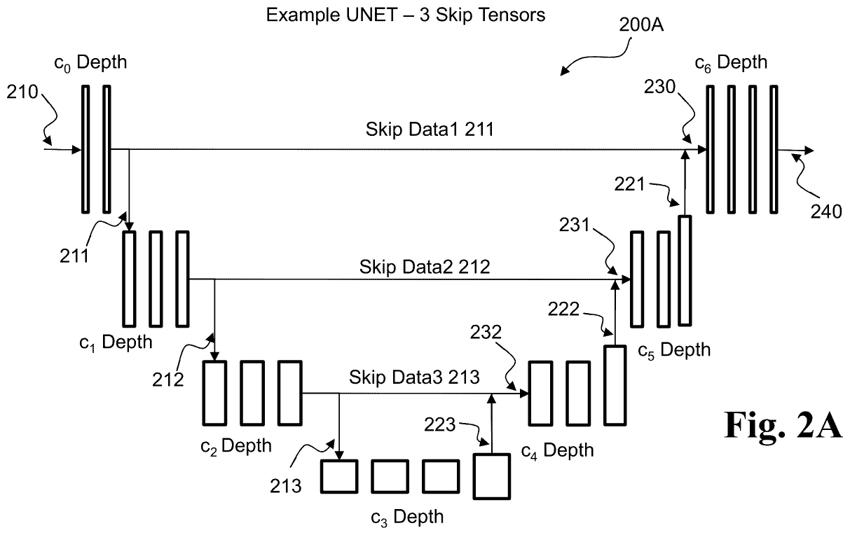

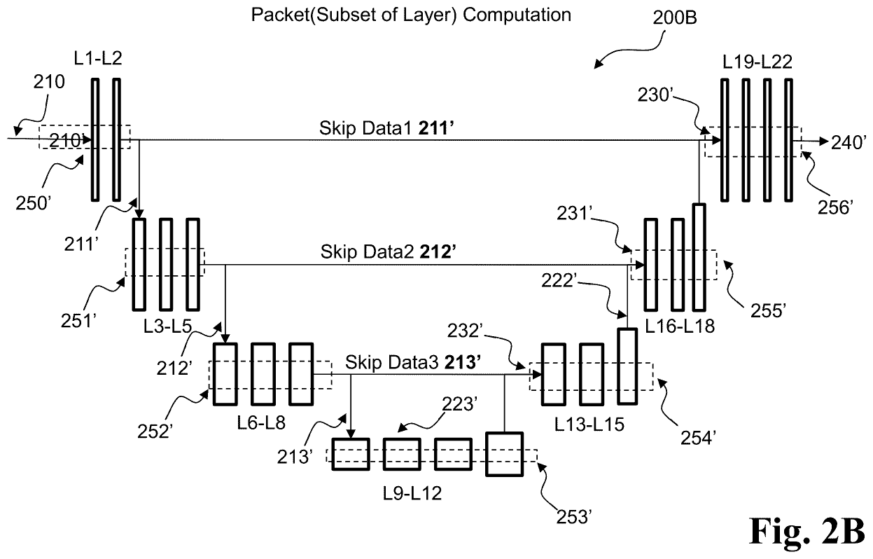

One of the challenges of neural network systems is the management of high-speed and slower-speed memory. High-speed memory is typically found on the NPU semiconductor while slower-speed memory is typically found off-chip, DDR memory. A neural processing system can include memory on the NPU and off-chip memory. On-chip memory can be up to a thousand times faster than access to off-chip memory such as DDR memory. Further, the power required to move data on/off-chip is detrimental to a system's performance. However, on-chip memory is expensive and thus not provided in limitless quantities. Further, the processing capability of an NPU can be sufficiently fast, such that it is more efficient and has less time delay recomputing intermediate tensor values than saving them to off-chip memory. The description of FIGS. 1A-1D provides general information on the architecture of neural networks. FIGS. 2A-2C provides an example of one neural network architecture, a U-NET, that would benefit from the memory management and recomputing or partially recomputing of skip connections within a neural network.

### Neural Networks Overview

One of the core techniques in artificial intelligence (AI) is the use of artificial neural networks (ANNs). Artificial neural networks, hereinafter referred to as neural networks, first learn from a set of training data and store that learning in a set of weight matrices. The neural network is then later used to make logical inferences by applying new input data to the neural network with the stored weight matrices. Artificial neural networks were originally designed to be analogous to the biological neuron networks in animal brains.

FIG. 1A illustrates a conceptual diagram of a very simple single-layer four-input artificial neural network 10A. Referring to FIG. 1A, an input data vector (made up of inputs 101 to 104) is provided with training data (not shown) during training sessions and then with new input data when the artificial neural network 10A is used to make inferences. The input data vector (made up of inputs 101 to 104) is processed with weight data in a weighted matrix 120 to create an output data vector (made up of outputs 161 to 164). Many different types of data processing may be performed using weighted matrix 120 (such as a Hadamard product, Frobenius inner product, matrix addition, etc.). The input data vector can be referred to as an input data tensor, and each of the individual inputs can be referred to as input data values. Additionally, the input data vector or tensor may be of multiple dimensions. Two dimensions can represent an image, and three dimensions represent a volume.

After processing the input data vector 101-104) with the weighted matrix 120 the system creates the output data vector or output data tensor 161-164. The output data vector 161 to 164 can be combined by an output function 170 to create a final output or output tensor 191 for the artificial neural network 10A. Each element of the output data vector is referred to as an output data value. The output function 170 can be referred to as an activation function. During training sessions, the output data vector 161-164 can be compared with a desired target output (not shown), and the difference between the calculated output data and the desired target output may be used to adjust the weight data within weight matrix 120, also referred to as a layer, to improve the accuracy of the artificial neural network 10A inference 191.

Note that the four-input artificial neural network of FIG. 1A illustrates just one example of a simple small artificial neural network 10A. Artificial neural networks may be constructed much wider than just four inputs. Further, multiple independent artificial neural networks may be used in parallel, and the outputs of the independent artificial neural networks may be combined.

Artificial neural networks may comprise many layers of weight matrices so that a very complex computational analysis of the input data may be performed. For example, FIG. 1B illustrates a three-layer artificial neural network 10B wherein the input data vector or tensor (made up of inputs 101 to 104) is processed with a first weighted matrix 121 to create a first intermediate data vector or tensor (made up of intermediate data values 141 to 144). Next, the first intermediate data vector 141-144) is processed with a second weighted matrix 122 to create a second intermediate data vector or tensor (made up of intermediate data values 151 to 154). Then, the second intermediate data vector 151-154 is processed with a third weighted matrix 123 to create an output data vector or tensor (made up of output data values 161 to 164). Output data vector 161-164) may then be processed by output function 170 to create a final output 191. Alternatively (or in addition to), the output data vector (made up of output data values 161 to 164) can also be used as intermediate data that is fed into additional artificial neural network layers (not shown) such that very complex hierarchical artificial neural networks may be created.

One aspect of the neural network 10B, is that the network 10B is fully connected. Thus, computing any intermediate data value requires the weighting 121 of the prior input vector/tensor or prior intermediate vector/tensor. As will later become more relevant, a row of the neural network cannot be calculated without calculating all of the other rows in the neural network. Thus, each layer 121, 122, and 123 has to be calculated to generate any of the output data values 161-164.

### Skip Connections

In artificial neural networks, each neural network layer may be dependent on information from other than just the preceding neural network layer. For example, FIG. 1C illustrates the neural network 10C of FIG. 1B with additional data dependencies for some layers. Specifically, one additional data dependency in the third network layer from first layer output data value 141 (and second layer input data value 141) along connection 109 and through the weight matrix operation 123. Another additional data dependency exists from input data value 104 along connection 111 through the weight matrix operation 123 to second layer output data 154.

The two additional data dependencies along connections 109 and 111 are often referred to as “skip connections” since the data skips one or more layers and then is used in a later neural network layer. In some neural network architectures, an entire intermediate data vector is connected to another layer as input. One method of handling such skip connections is to store the data in on-chip or off-chip memory and then later reload that data for the computation in the later layer. As will be discussed later in more detail, the U-NET neural network architecture incorporates the skip connection tensor at different levels in the architecture.

### Parallel Operations

It is well known that due to the use of matrices, the computing operations to be performed have a significant amount of parallelism within each layer that can be exploited such that computations can be performed in parallel. Specifically, the matrix multiplication operations require many independent multiplication operations that can be performed in parallel. However, artificial neural networks can also include inherent parallelism that can be exploited between the different layers of an artificial neural network.

FIG. 1D illustrates a two-layer neural network 10D that receives an input tensor 100, processes that input tensor 100 through a first layer with a first weight matrix 121 to create an intermediate tensor 140, and then processes that intermediate tensor 140 through a second layer with a second weight matrix 122 to create an output tensor 150. However, in the two-layer neural network of FIG. 1D is not fully connected. Not every input data value in input tensor 100 is connected to every intermediate value in intermediate tensor 140. Similarly, not every intermediate data value in intermediate tensor 140 is connected to and affects every output value in output tensor 150. Therefore, some operations in a neural network layer can be performed before all of the input values from the input tensor are ready. In this network configuration, on-chip memory can be reused to reduce the memory footprint of the multilayer neural network.

For example, intermediate value 141 only depends on input data values 101 and 102. Similarly, intermediate value 142 only depends on input data value 101. Thus, intermediate values 141 and 142 can be computed before input values 103 and 104 are available yet and thus can be calculated in parallel with the computations needed to calculate input values 103 and 104. Furthermore, output value 151 only depends on intermediate values 141 and 142. Thus, the calculation for output value 151 can be performed simultaneously with the computations needed to calculate input values 103 and 104.

In some embodiments, a packetized system is used to create individual fragments of work such that each individual work fragment can be dispatched as soon as the required input data values are available. In this manner, individual work fragment can be created for the calculations needed to create intermediate value 141, intermediate value 142, and output value 151. Those work fragments can be executed as long as input values 101 and 102 are available and in parallel with the calculations needed to create input values 103 and 104. An example of a packetized system is disclosed in the U.S. patent application with Ser. No. 17/970,450 filed on Oct. 20, 2022 titled “METHOD AND APPARATUS FOR USING A PACKET ARCHITECTURE TO PROCESS NEURAL NETWORKS IN A NEURAL PROCESSING UNIT”, and is hereby incorporated by reference. The teachings of this document are ideally implemented in such a system in order to best exploit the parallelism inherent in the neural networks being processed.

### Processing a U-Net Neural Network

As illustrated with reference to FIGS. 1A, 1B, 1C, and 1D, artificial intelligence relies upon large amounts of very computationally intensive matrix operations in order to initially learn using training data to adjust the weights in the weight matrices. Later, those adjusted weight matrices are used to perform complex matrix computations with a set of new input data to draw inferences from the new input data. Fortunately, the linear algebra matrix operations used in an artificial neural network allow for many performance optimizations since there is a significant amount of parallelism in the matrix computational tasks. Thus, many specialized processors for artificial intelligence applications have been created.

### U-Net Overview

U-Net is a convolutional neural network (CNN) architecture designed for semantic image segmentation tasks. The U-Net architecture is particularly effective for tasks where the goal is to segment an image into different classes or categories, such as medical image segmentation, cell nucleus segmentation, and other types of segmentation.

The architecture of U-Net resembles the letter “U,” which is where its name comes from. It consists of an encoder pathway and a corresponding decoder pathway. The encoder is responsible for capturing and abstracting the features from the input image, while the decoder pathway uses these features to generate a segmented output map. Other architectures can be used for image classification including LeNet, AlexNet VGG, GoogleLeNet, Inception V3, and Inception Bn. More details of the U-NET architecture can be found in the paper: “U-Net: Convolutional Networks for Biomedical Image Segmentation; Olaf Ronneberger, Philipp Fischer, and Thomas Brox, Computer Science Department and BIOSS Centre for Biological Signalling Studies, University of Freiburg, Germany, ronneber@informatik.uni-freiburg.de, WWW home page: http://lmb.informatik.uni-freiburg.de/” which is incorporated by reference.

The encoder consists of a series of convolutional and pooling layers. These layers progressively reduce the spatial dimensions of the input image while capturing higher-level features. At the bottom of the “U,” there's a bottleneck layer that captures the most abstracted features of the input.

The decoder pathway consists of a series of upsampling and transposed convolutional layers. These layers gradually increase the spatial dimensions of the features and concatenate them with the corresponding features from the encoder. This process helps to recover the spatial information and refine the segmentation output.

Referring to FIG. 2A, one embodiment of a U-NET neural processing data flow 200A is shown. The depth c0-c6 can be referred to as levels where the multilayer neural network processes an image and provides a classification of each encoded input. In one architectural embodiment, the multi-channel neural network processing going down through the levels of the “U” side, c0-c3, are encoders of image data features. The decoders are levels c4-c6 going the up-side of the “U.”

The input data tensor 210 can consist of one or more channels. A single channel can be used for grayscale data, and three channels for color data. The neural network 200 can provide multiple channels of convolutional neural network processing trained and configured to recognize and classify input image features. If there are twenty feature channels, the output of this first level 211, will be the size of the input image (512×512 for example) times one for grayscale image input channel, times the twenty feature channels. At each new level, cn-cn+1, the image data size is halved and the number of channels is doubled to classify more high level features within the image data. The skip connection tensor 211, 212, 213 is saved and used on the other side of the “U” during the decoding process to maintain spatial data for the features identified by the neural network channel processing in levels c0-c3.

Processing along the right side of the U-NET, the neural network levels c4-c6 acts as a decoder of the feature identified by the neural levels c0-c3. The skip connection tensor 211, 212, and 213 are incorporated by the decoder neural network levels c4-c6, to capture the spatial information for the decoded image 240. During decoding, the skip connection tensor 213, along with the output of the lower level c3 223 and the skip connection tensor 213 is provided as the intermediate tensor input 232 for the c4 level. For the c5 level, the output of the lower level c4 222 and the skip connection tensor 212 is provided as the intermediate tensor input 231. For the c6 level, the output of the lower level c5 221 and the skip connection tensor 211 is provided as the intermediate tensor input 230.

Referring to FIG. 2B, illustrates the processing flow of the U-NET neural network architecture 200B in terms of layers L1-L22 and utilizing portions 210′ of an input data tensor 210. The input portion 210′ can be a segment, portion, a subset or data from a packet of the input tensor 210. Preferably, the portions 210′ are adjacent elements of the input tensor 210.

One characteristic of the U-NET architecture is that the layers of the multilayer neural network are not fully connected. Thus, even when the input is a subset or portion 210′ of the input data tensor 210, there are portions of the neural network layers L1-L22 that can be computed. This can include generating a portion of the output tensor 240′. These portions of the layers L1-L22, generate intermediate data tensors as shown within the layer portions 250′, 251′, 252′, 253′, 254′, 255′, and 256′. As a portion of the input data tensor 210′ is computed, and the computation of the associated portions of the layers L1-L22 can be computed including a portion of the output 240′.

The portions can be sequential segments or regions of an input image. Typically, these are squares of image pixels for a two-dimensional tensor. The regions can be as small as 3×3, 5×5 pixels or a larger region of an image. Beneficially, the processing of the two-dimensional tensor through the encoder and decoder layers, L1-L22, one portion at a time is that the processing memory footprint can be reduced in relation to processing each entire layer. Once a portion of input data 210′ is processed from the input L1 through the output L22, intermediate data used in the layer calculations can be overwritten or freed for other calculations.

While not shown, layers such as L2 220′ can have multiple channels and generate temporary data that is not needed after the calculation of the associated portion of the output data tensor 240′. NPU on-chip memory is much faster than off-chip DDR memory thus it is desired not to store data off-chip memory such as DDR memory for system computational speed.

A set of layers can be processed before processing the next set of layers. For example, level 1, which includes L1-L2 could be processed before moving to layers L3-L5. Again, the memory used for temporary computation within a set of layers can be overwritten and thus reduce the memory footprint. However, the skip connection tensor, generated during the computation, will need to be used by later layers and, in one embodiment, not overwritten. For example, the skip connection tensor 211′ is used by layers L19-L22. The skip connection tensor data is stored in memory and not overwritten during computation in subsequent calculations. The storage of the skip connection tensors 211′, 212′, and 213′ can be on on-chip memory or slower off-chip DDR memory. However, off-chip memory has power and access time cost.

In some embodiments, the multilayer neural network can process multiple Jobs for a plurality of users in parallel. For each Job there can be more than one recompute.

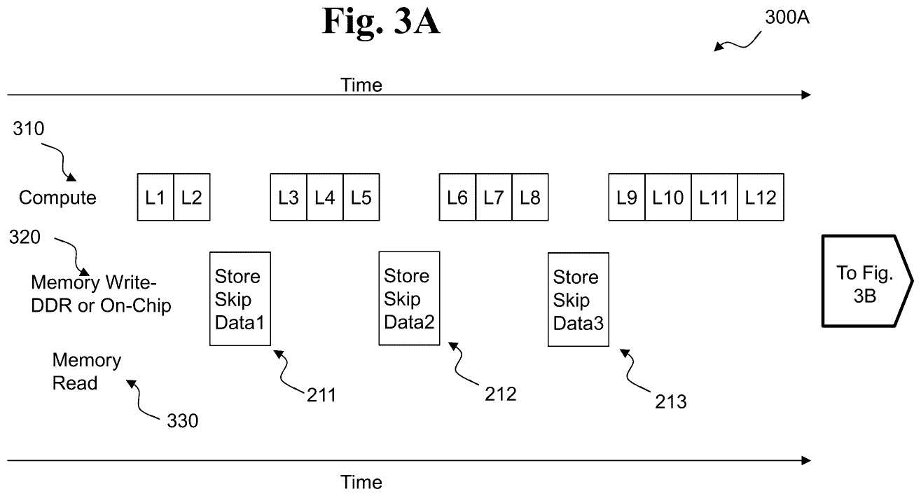

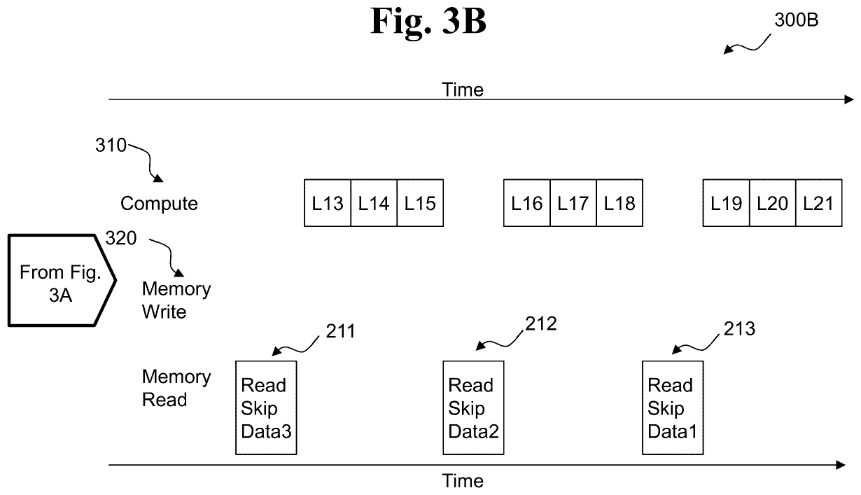

Referring to FIGS. 3A and 3B shows one timing diagram of the processing layer flow 310 of a U-NET neural network by an NPU in respect to the memory storage 320 and memory reads 330 of the skip connection tensor from memory for further processing in subsequent neural network layers. The skip connection tensor 211, 212, and 213 can be stored in either DDR memory or on-chip memory.

### Recompute of Skip Connection Tensor

To reduce the power consumption and latency from memory operations, the intermediate data tensors associated with one or more of the skip connection tensors can be recomputed instead of storing the skip connection tensor and weight data, to external memory and then reloading that data. Further, recomputing of one or more skip layers that generate a skip connection tensor can reduce the on-chip memory footprint and the neural network system cost.

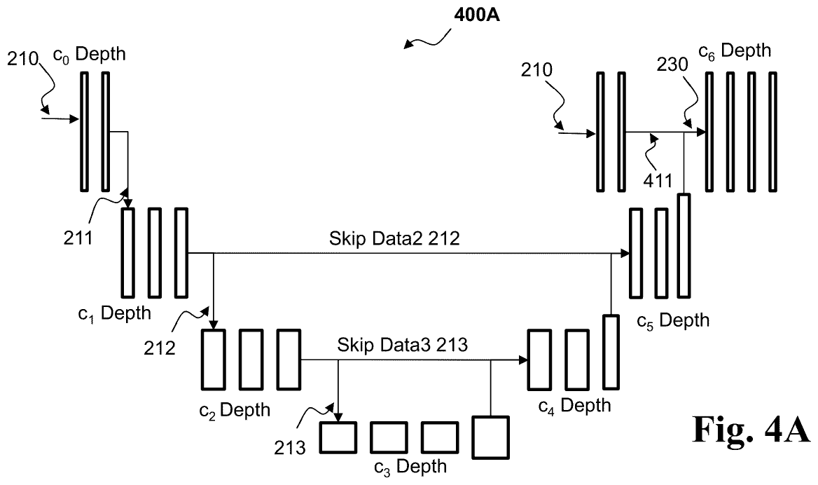

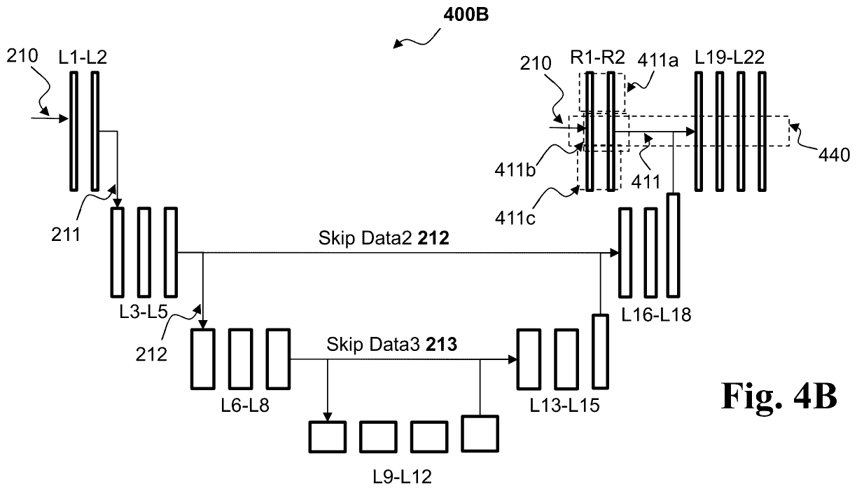

Referring to FIG. 4A, a U-Net neural network is shown where the skip connection tensor generated at the output of level c0, is not stored for later use on the corresponding decoding side (right rising side) of the U-Net and all or part of the memory associated with the skip connection tensor is freed. This means that the memory associated with the skip connection tensor 211 and some or all the weights and intermediate tensors are freed, and the memory can be utilized in further computations. This reduces the memory footprint of the multilayer neural network but at the expense of requiring recomputing the skip connection tensor. However, the recomputing of the skip connection tensor 411 can result in a processing speed gain because the time to store and retrieve the skip connection tensor 211 and associated weight can be greater than the time to recompute the skip connection tensor 411. This multilayer neural network 400A is identical to the multilayer neural network of 200A—FIG. 2A, except for the recomputing of first skip connection tensor 411.

The neural network processing continues to the second level c1 and the third level c2 where additional skip connection tensors 212 and 213 are calculated and fed into their respective subsequent level of neural network layer. At the bottom of the U-Network, level c3 the trained for features are identified by the neural network. On the right side of the U-network, the computation levels c4, c5, and c6 are computed. The skip connection tensor 213 is fed back into level c4 where the layers generate an input for the c5 level input. The skip connection tensor 212 is also input is also provided as input for the c5 level input. The tensor 212 will be accessed from memory, either on-chip (wideband high-speed memory) or off-chip (DDR) memory. This was also true for skip connection tensor 213 and for other skip connection tensors in architectures with more levels and layers. See description of FIG. 2A for more details.

The c5 level output is fed into the c6 level input 230. The skip connection tensor 211 is recomputed generating the recomputed skip connection tensor 411 which is provided as to the c6 level input 230.

The recomputing of the skip connection tensor 211 as tensor 411 is performed by accessing the input tensor 210 and inputting it into the c0 level layers. This can require accessing the weights for the c0 level and again computing the intermediate tensor values for the c0 to generate at the output of level c0, the recomputed skip connection tensor 411.

FIG. 4B illustrates the multilayer U-Net neural network of FIG. 4A described in terms of layers L1-L22. While a U-Net is shown, the concepts described for recomputing skip connection tensors, the concept can be applied to other neural network architectures. The input tensor 210 is input into the c0 level with the L1-L2 layers. While only two layers are shown, the first level can include more or fewer layers. As discussed for FIG. 4A, the skip connection tensor 211 is recomputed generating an identical skip connection tensor 411. The recomputing of the skip connection tensor 411 and associated intermediate tensors can be performed in different ways. In one embodiment, the intermediate tensors for layers R1-R2 are recomputed one layer at a time and then proceed to the next layer until the recomputed skip connection tensor is complete.

In another embodiment, the recomputing of the R1-R2 layers can be performed in segments or portions until the first layer R1 are complete layer is fully computed, and then proceed with computing segments or portions of the R2 layer.

In another embodiment, the skip connection tensor recomputing is performed by segments 411a, 411b, and 411c across of all the layers R1-R2 of the level c0. After each segment is recomputed, the associated memory can be freed and reused. The recomputing of the segments or portions of 411a, 411b, and 411c can occur in any order or in a random sequence.

In another embodiment, the recomputing of a segment or portion includes computing a segment 440 across multiple levels, c0 and c6, layers R1-R2, and L19-L22.

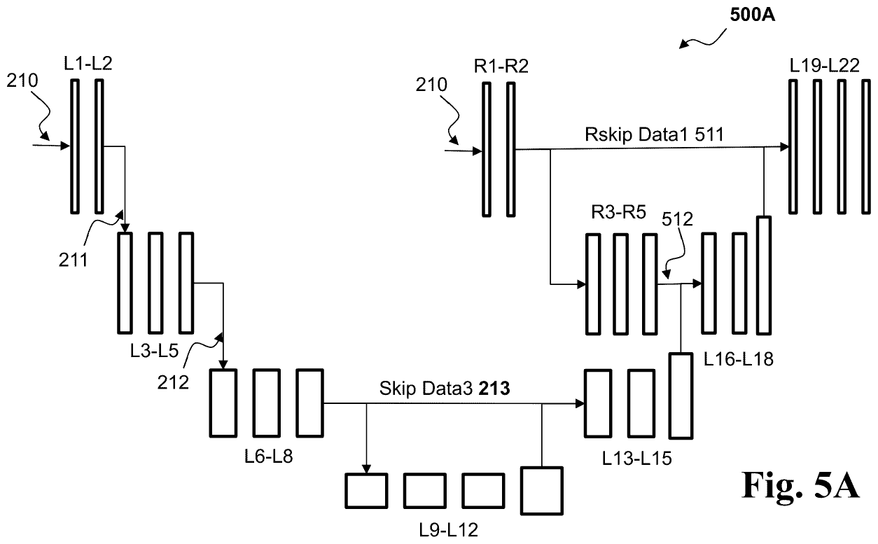

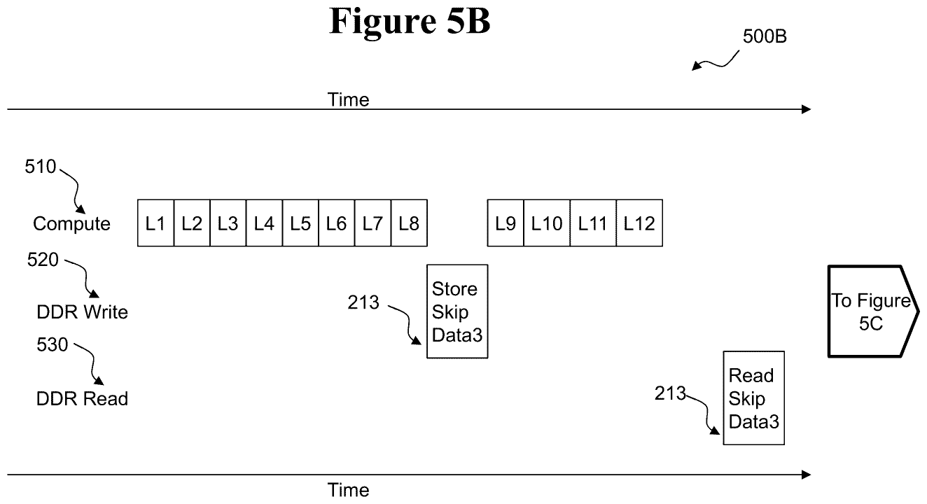

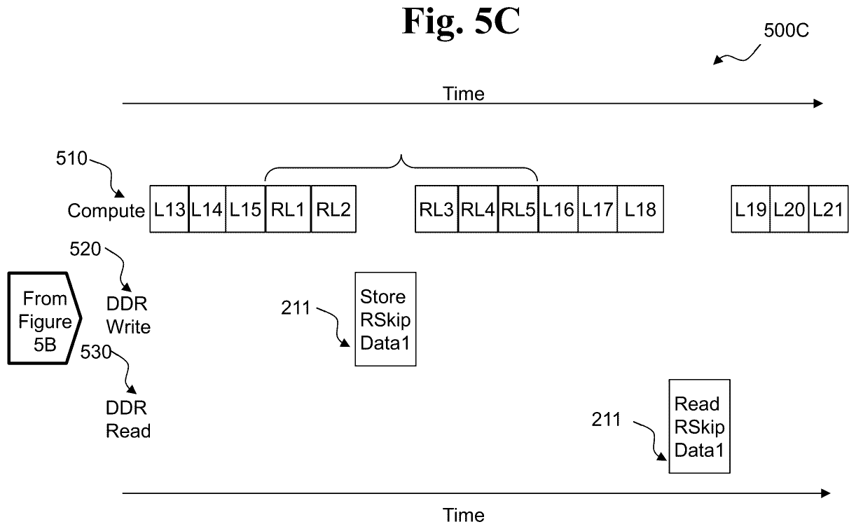

Referring to FIG. 5A, shows a multilayer neural-network embodiment where more two skip connection tensors are recomputed. In the shown embodiment the first skip connection tensor 211 is recomputed 511 as described above for FIG. 4C. The second skip connection tensor 212 is also recomputed 512 and used as input to the next higher level. Any combination of skip connection tensor recomputing is possible.

Referring to FIGS. 5B and 5C, shows a timing diagram of the processing layer flow 510 of a U-NET neural network by an NPU in respect to the memory storage 520 and memory reads 530 of recomputing two skip connection tensors from memory for further processing in subsequent neural network layers. The skip connection tensor data 211 and 213 can be stored in either DDR memory or on-chip memory.

Tapering Weight Matrix Data into a Neural Processor

The weight matrix data represents a large amount of data that must be loaded into a neural processor in order to perform neural network calculations. One technique used by the disclosed system is to load in more than one set of weight matrices such that the neural processor can work on processing work fragments for the same layer, for several different neural network layers, or even for several different neural networks without reloading weight matrix data.

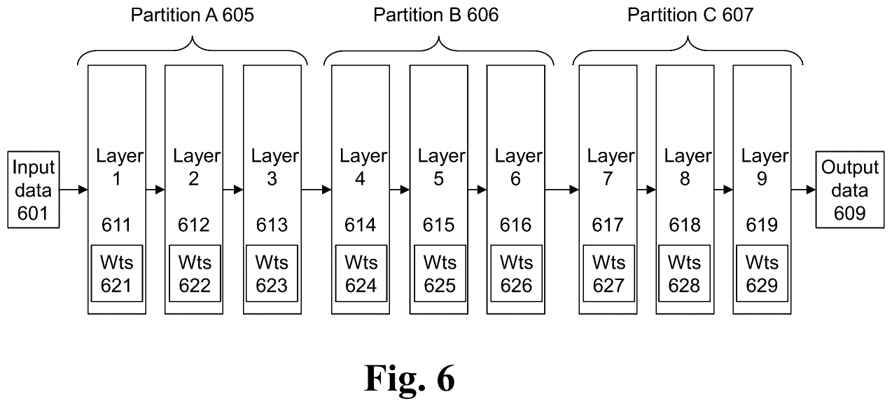

FIG. 6 conceptually illustrates a nine-layer neural network that receives a set of input data 601, processes that input data 601 through nine neural network layers (611 to 619) and outputs a set of result data 609. To reduce the loading and reloading of weight matrix data, the system may load several sets of weight matrices and process several layers at a time. In the example of FIG. 6, the nine-layer neural network has been divided into three “partitions” of three neural network layers each: Partition A 605, Partition B 606, and Partition C 607. Each partition of neural network layers may be processed together as a group. Thus, work fragments from any of the layers in a partition may be processed if the required input data is available for the work fragment.

For example, to process Partition A 605, the neural processor loads in weight matrices 621, 622, and 623 to process neural network layer 1 611, neural network layer 2 612, and neural network layer 3 613, respectively. In this manner, the neural processor can process work fragments for neural network layer 1 611, neural network layer 2 612, and neural network layer 3 613 by only loading those weight matrices once. Note that in embodiments that use work fragments then work fragments from any of those three neural network layers can be processed if the needed input data for those work fragments are available. Thus, work fragments may be processed out of a traditional neural network processing order. As the system completes the processing for Partition A 605, the system can then load in the weight matrices (624, 625, and 626) for the next partition of neural network layers, Partition B 606, consisting of neural network layer 4 614, neural network layer 5 615, and neural network layer 6 616.

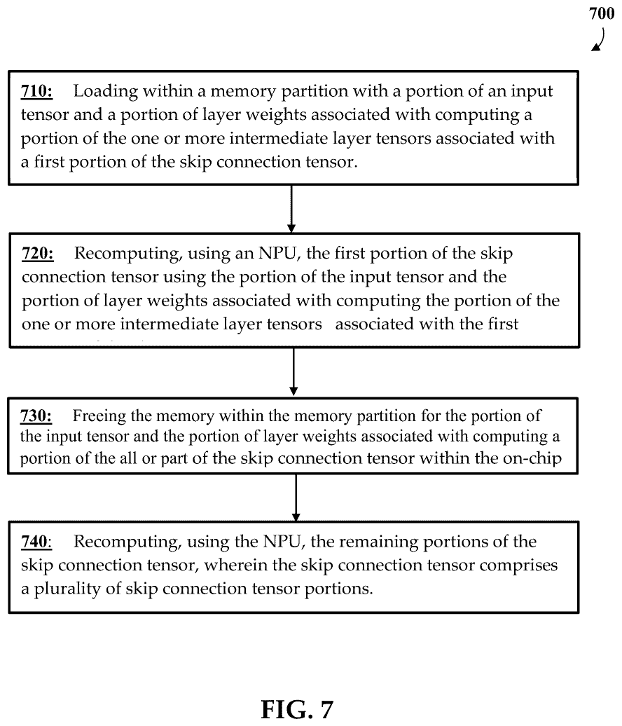

FIG. 7 shows a flow chart illustrating process 700 for recomputing a skip connection tensor within a multilayer neural network. In one implementation, the system includes a neural network unit (NPU) to compute a multilayer neural network. The system can include fast, wide on-chip memory and off-chip memory, including DDR memory. A general CPU processor can be included to configure and control the neural network processing system. The memory system can include partitions as part of the memory management.

The process 700 for recomputing a skip connection tensor starts by loading in memory a portion of an input tensor. The memory can be high-speed on-chip memory or off-chip DDR memory. DDR memory is slower, can require more power, but is less costly than on-chip memory. A portion is a subset of the input tensor. Preferably a portion is a continuous segment of a single dimension tensor or a rectangular area of a two-dimensional tensor. Also, the neural network weights associated with the portions of layer weights associated with computing a portion of the one or more intermediate layer tensors associated with a first portion of the skip connection tensor, are loaded into memory. Another way of viewing this for a two-dimensional tensor, the weights used to compute a rectangle for the neural network layers associated with the input tensor rectangle to generate the associated skip connection tensor rectangle are loaded. See block 710.

Next the first portion of the skip connection tensor is recomputed using an NPU. The recomputed portion generates an identical result to when the skip connection tensor was computed. The computing a first portion of the skip connection tensor uses the portion of the input tensor and the portion of layer weights associated with computing the portion of the one or more intermediate layer tensors associated with the first portion of the skip connection tensor. See block 720.

Upon completing the recomputing a portion of the skip connection tensor, the memory used for the associated weights and intermediate layer tensors can be freed for other multilayer neural network processing needs. This memory can be on-chip or off chip memory. On-chip memory can be high-speed memory, and off-chip memory can be DDR memory. and the portion of layer weights associated with computing a portion of the all or part of the skip connection tensor within the on-chip memory partition. See block 730.

The entire skip connection tensor can be recomputed portion by portion or segment by segment. The next portion of the skip connection tensor can use the memory freed from the recomputing of the first portion of the skip connection tensor. The portion of the skip connection tensor can be computed in any order. Further, some of the See block 740.

portions of the skip connection tensor can have been saved and not require recomputing. Thus, in one embodiment, the entire skip connect tensor does not have to be recomputed.

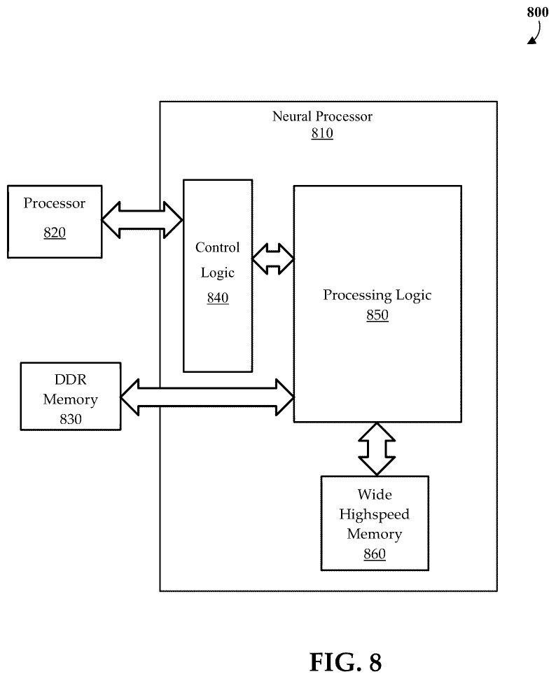

FIG. 8 is a block diagram of one embodiment of a multilayer neural network system 800. The system is comprised of a neural processor 810, a processor 820, and external memory 830. The processor 820 can provide overall configuration, neural network control, and results processing. The external memory can store intermediate layer tensors and layer weights.

The processor 820 can provide configuration and high-level control for processing a multilayer neural network. The processor 820 can be a digital signal processor, a microprocessor or other customized computational logic suitable for the above-mentioned functions.

The neural processor 810 can include control logic 840, processing logic 850, and wide high-speed memory 860 also referred to as on-chip memory. The control logic 840 includes the microelectronics required to control the data flow from memory to the processing logic 850. The sequencer 840 can also provide control over the on-chip memory 860 for the flow of tensor data to and from the processing logic 850 and the on-chip memory 860 and off-chip memory or external memory 830.

The processing logic 850 can include electronics for a matrix of multiply and accumulate logic configured to perform parallel matrix operations in support of the processing of a multilayer neural network.

The on-chip memory 860 can be designed to include partitions and provide a wide memory path to and from the processing logic 850. Further, portion of the on-chip memory can be shared between Jobs and is referred to as shared memory. Additionally, the off-chip memory 830 can be utilized as shared memory and can also be referred to as shared memory.

We claim:

1. A method of processing a multilayer neural network including generating a skip connection tensor, said method comprising:
loading within a memory partition with a portion of an input tensor and a portion of layer weights associated with computing a portion of the one or more intermediate layer tensors associated with a first portion of the skip connection tensor;
recomputing, using an NPU, the first portion of the skip connection tensor using the portion of the input tensor and the portion of layer weights associated with computing the portion of the one or more intermediate layer tensors associated with the first portion of the skip connection tensor; and
freeing the memory within the memory partition for the portion of the input tensor and the portion of layer weights associated with computing a portion of the all or part of the skip connection tensor within the on-chip memory partition.

2. The method of claim 1, wherein the recomputing includes a portion of one or more additional tensors.

3. The method of claim 1, wherein the input tensor is computed or loaded from off-chip memory before loading within the memory partition.

4. The method of claim 1, wherein the recomputing of skip connection tensor can be for a plurality of intermediate layer tensors.

5. The method of claim 1, further comprising generating additional skip connection tensors.

6. The method of claim 1, further comprising recomputing, using the NPU, the remaining portions of the skip connection tensor, wherein the skip connection tensor comprises a plurality of skip connection tensor portions.

7. The method of claim 7, wherein the portions of skip connection tensor portions are computed in any order.

8. The method of claim 1, wherein the memory partition is highspeed wideband memory.

9. The method of claim 7, wherein the memory partition includes at least one layer of the multilayer neural network and the associated layer weights.

10. A system for processing a multilayer neural network including at least one skip connection tensors, said system comprising:
at least one NPUs, the MPU comprising:
a matrix of multiply and accumulate processors;
memory; and
a controller configured to perform a method, the method comprising:
loading within a memory partition with a portion of an input tensor and a portion of layer weights associated with computing a portion of the one or more intermediate layer tensors associated with a first portion of the skip connection tensor;
recomputing, using an NPU, the first portion of the skip connection tensor using the portion of the input tensor and the portion of layer weights associated with computing the portion of the one or more intermediate layer tensors associated with the first portion of the skip connection tensor; and
freeing the memory within the memory partition for the portion of the input tensor and the portion of layer weights associated with computing a portion of the all or part of the skip connection tensor within the on-chip memory partition.

11. The system of claim 10, wherein the recomputing includes a portion of one or more additional tensors.

12. The system of claim 10, wherein the input tensor is computed or loaded from off-chip memory before loading within the memory partition.

13. The system of claim 10, wherein the recomputing of skip connection tensor can be for a plurality of intermediate layer tensors.

14. The system of claim 10, the controller further comprising generating an output or end tensor of the multilayer neural network; and
wherein the output or end tensor is input into a second neural network.

15. The system of claim 10, wherein the loading a portion of an input tensor is includes loading from on-chip memory, external memory, and shared memory.

16. The system of claim 10, further comprising generating additional skip connection tensors.

17. The system of claim 10, further comprising recomputing, using the NPU, the remaining portions of the skip connection tensor, wherein the skip connection tensor comprises a plurality of skip connection tensor portions.

18. The system of claim 17, wherein the portions of skip connection tensor portions are computed in any order.

19. The system of claim 10, wherein the memory partition is highspeed wideband memory.

20. The method of claim 19, wherein the memory partition includes at least one layer of the multilayer neural network and the associated layer weights.

21. A non-transitory computer-readable storage medium having embodied thereon instructions, which when executed by at least one NPU controller, perform steps of a method for processing a multilayer neural network including at least one skip connections, the method comprising:
loading within a memory partition with a portion of an input tensor and a portion of layer weights associated with computing a portion of the one or more intermediate layer tensors associated with a first portion of the skip connection tensor;
recomputing, using an NPU, the first portion of the skip connection tensor using the portion of the input tensor and the portion of layer weights associated with computing the portion of the one or more intermediate layer tensors associated with the first portion of the skip connection tensor; and
freeing the memory within the memory partition for the portion of the input tensor and the portion of layer weights associated with computing a portion of the all or part of the skip connection tensor within the on-chip memory partition.

22. The method of claim 21, wherein the recomputing includes a portion of one or more additional tensors.

23. The method of claim 21, wherein the input tensor is computed or loaded from off-chip memory before loading within the memory partition.

24. The method of claim 21, wherein the recomputing of skip connection tensor can be for a plurality of intermediate layer tensors.

25. The method of claim 21, further comprising generating additional skip connection tensors.

26. The computer program product of claim 21, further comprising recomputing, using the NPU, the remaining portions of the skip connection tensor, wherein the skip connection tensor comprises a plurality of skip connection tensor portions.

27. The computer program product of claim 21, wherein the portions of skip connection tensor portions are computed in any order.

28. The computer program product of claim 21, wherein the memory partition is highspeed wideband memory.

29. The computer program product of claim 28, wherein the memory partition includes at least one layer of the multilayer neural network and the associated layer weights.
